(19) United States
(12) Patent Application Publication
(10) Pub. No.: US 2009/0127985 A1
(43) Pub. Date: May 21, 2009

(54) COMBINATION OF DISK MOTOR AND MACHINE

(75) Inventors: HOLGER HOFFMANN, Hessdorf (DE); ROLAND SCHULTHEISS, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/273,153

(22) Filed: Nov. 18, 2008

(30) Foreign Application Priority Data
Nov. 19, 2007 (EP) 07022402

(51) Int. Cl. H02K 7/00; H02K 21/24

(52) U.S. Cl. 310/75 R; 310/156.32

(57) ABSTRACT

An electric disk motor having a primary part and a secondary part is connected to a machine by bearing-mounting the primary part on a drive shaft of the machine and by securely fixing the primary part to a supporting structure for support of the machine.

### CROSS-REFERENCES TO RELATED APPLICATIONS

This application claims the priority of European Patent Application, Serial No. EP07022402, filed Nov. 19, 2007, pursuant to 35 U.S.C. 119(a)-(d), the content of which is incorporated herein by reference in its entirety as if fully set forth herein.

### BACKGROUND OF THE INVENTION

The present invention relates, in general, to the field of attaching an electric disk motor to a machine.

Nothing in the following discussion of the state of the art is to be construed as an admission of prior art.

A disk motor represents a special design of an electrical machine. In order to use a direct drive which works on the principle of the disk motor, a mechanical structure is required for connecting the drive to the appropriate machine, such as a machine tool or a production machine, for example. Previous drive concepts for machines, for example machine tools, are based for example on a design comprised of one or more electric motors which transmit the required torques and speeds to a drive shaft of the machine via an intermediate gearbox. Different gearboxes or different electrical drives (electric motors) are used depending on the power level required, i.e. the drive torque required. Drive concepts of this kind are complicated to install and incur high costs due to the use of electric motors and gearboxes.

It would therefore be desirable and advantageous to provide an improved mechanical interface or machine connection for connecting an electric disk motor to a machine to obviate prior art shortcomings.

### SUMMARY OF THE INVENTION

According to one aspect of the present invention, a combination electric disk motor with primary part and secondary part, and machine with drive shaft includes a supporting structure for support of the machine, wherein the primary part is bearing-mounted on the drive shaft and securely fixed to the supporting structure. Examples of such a machine may include, but not necessarily is limited thereto, a production machine, such as a print machine, wood processing machine, a machine tool or a recycling machine.

According to another feature of the present invention, the disk motor has a motor housing, wherein the primary part is securely fixed to the motor housing and may form the stator of the disk motor, i.e. of the electrical direct drive. The motor housing of the disk motor can be bearing-mounted on the drive shaft of the machine and is releasably connected to the supporting structure by a connection assembly. The secondary part may form the rotor of the disk motor and is connected in fixed rotative engagement with the drive shaft so that the secondary part is able to rotate with the drive shaft.

According to another feature of the present invention, the primary part and the secondary part may have each a disk-shaped configuration and can be arranged opposite one another in an axial direction in side-by-side relationship on the drive shaft and form a disk-shaped or ring-shaped air gap. Unlike conventional electrical machines, in which the electromagnetic fields or forces act in a radial direction, the electromagnetic fields and forces in a disk motor develop in the axial direction.

According to another advantageous feature of the present invention, the primary part may have a plurality of curved or straight primary part elements, wherein each primary part element has a single or polyphase winding. The primary part elements can be arranged in a ring shape or circular shape on a support plate at a defined distance and angle from one another. Each primary part element may have a polyphase, in particular three-phase, winding for connection to a three-phase network. The advantage of using straight primary elements is that conventional primary parts from standard linear motors can be used here. This is cost-effective. Curved primary part elements, on the other hand, have the advantage that a ring structure or circular structure can be reproduced more easily. At the same time, the primary part can be constructed so that a different number of primary part elements can be arranged on one base disk or support plate. The number of primary part elements can hereby be selected to best suit the required power and torque.

The secondary part likewise may have a plurality of curved or straight secondary part elements which are arranged on a base disk. However, the secondary part can also be designed so that together the secondary part elements themselves produce the disk or a ring.

As the secondary part is preferably used as rotor, the secondary part elements may have a predefined number of permanent magnets which are suitably configured to suit the disk radius of the base disk. Each individual secondary part element may have three permanent magnets, for example, wherein the permanent magnets themselves can be designed in one or more parts. Here too, the number of permanent magnets per secondary part element can be varied to best suit the required power density.

A disk motor offers the advantage that it is easy to variably adjust the torque or power density. The air gap between secondary part and primary part extends perpendicular to the drive shaft and can be designed with different widths. If the air gap is narrow or small, a higher power or higher torque can be transmitted. Less torque will be transmitted to the drive shaft as the air gap increases in width. Furthermore, the torque can be variably adjusted by adjusting the number of primary part elements on the primary part.

According to another feature of the present invention, a plurality of secondary parts and/or primary parts can also be arranged on the drive shaft.

Depending on the application at hand, the secondary part may be connected in fixed rotative engagement to the drive shaft by force, in a form-fitting manner or by material bonding so that the secondary part is able to rotate with the drive shaft. Advantageously, the secondary part, in particular the support plate of the secondary part, may be securely connected to the drive shaft for conjoint rotation by means of one or more ring clamping elements, hydraulic clamping elements, star washers, multiple splines, polygon connections or keys. The secondary part, in particular the support plate of the secondary part, can be shrunk onto the drive shaft.

According to another feature of the present invention, the support plate of the secondary part may have a plurality of radially arranged ribs. Ribs of this kind are used to absorb the forces resulting from the attractive forces of the primary part elements and the secondary part elements, which act axially on the support plate.

The motor housing of the disk motor may be made from rust-resistant material or contain rust-resistant materials, and may be comprised essentially of three elements, namely two circular disks and a hollow cylinder, wherein the hollow cylinder has opposite end faces, with the two circular disks respectively screwed to the end faces of the hollow cylinder. As a result, the opposite openings of the hollow cylinder are closed. In order to protect the inside of the motor housing from environmental effects such as dirt or dust, appropriate sealing material may be introduced between the disks and the hollow cylinder.

According to another advantageous feature of the present invention, each of the disks may have a central hole or recess for press-fitting a bearing to securely fix the motor housing on the drive shaft. The bearing in the central hole of one of the disks may hereby be configured as a fixed bearing, while the bearing in the central hole of the other one of the disks may be configured as a floating bearing to compensate a heat expansion of the motor housing. The bearings, for example grooved ball bearings, may be sealed by sealing rings.

According to another advantageous feature of the present invention, the connection assembly may include one or more torque support arms arranged on the machine side of the motor housing. The torque support arms can be designed in the form of hollow cuboids, which are open on one side, and may rest on a cylindrical bolt protruding from the supporting structure of the machine. The torque support arm of the motor housing in the form of a hollow cuboid can hereby be pushed over the cylindrical bolt on the machine supporting structure.

According to another advantageous feature of the present invention, the motor housing of the disk motor may have an air inlet and an air outlet for ventilation, in particular for positive or excess pressure ventilation, of the disk motor. Air inlet and air outlet are used for the internal ventilation of the disk motor, i.a. to conform to explosion-protection requirements. As a result of the ventilation, excess pressure is produced inside the motor housing in relation to the environment. This requires the provision of a ventilator or fan, which may be arranged for example directly on the motor housing in the vicinity of the air inlet.

In order to relieve stress on the bearings of the motor housing and the drive shaft, a support frame may advantageously be arranged on the supporting structure of the machine. As a result, there is no need for the drive shaft of the machine to fully support the weight of the disk motor and the weight of the motor housing, as these weights are partially transferred to the supporting structure of the machine via the support frame. Fingers, which engage in guide rails of the support frame may hereby be provided on the motor housing. The guide rails in the support frame also enable the motor to be moved with respect to the stationary supporting structure of the machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a plan view of a disk-shaped primary part;

FIG. 2 is a plan view of a disk-shaped secondary part;

FIG. 3 is a schematic illustration of a first embodiment of a disk motor;

FIG. 4 is a schematic illustration of a second embodiment of a disk motor;

FIG. 5 is a schematic illustration of a first embodiment of a disk motor and a machine, with the disk motor being attached to the machine;

FIG. 6 is a schematic illustration of a second embodiment of a disk motor and a machine, with the disk motor being attached to the machine;

FIG. 7 is a schematic illustration of a third embodiment of a disk motor and a machine, with the disk motor being attached to the machine;

FIG. 8 is a schematic illustration of a fourth embodiment of a disk motor and a machine, with the disk motor being attached to the machine; and

FIG. 9 is a perspective illustration of a support frame for use in the attachment of the disk motor to the machine as shown in FIG. 8.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

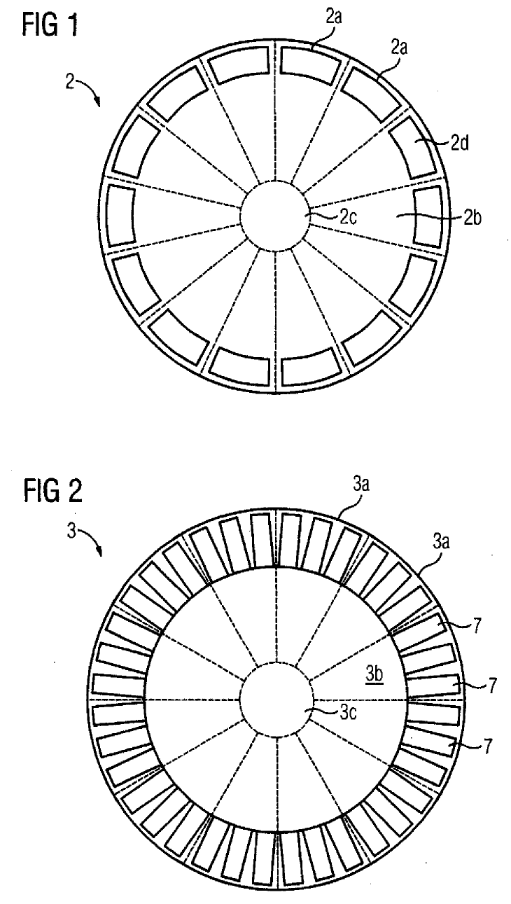

Turning now to the drawing, and in particular to FIG. 1, there is shown a disk-shaped primary part 2, which has a support plate 2b. A plurality of curved primary part elements 2a are arranged on the support plate 2b. By way of example, fourteen primary part elements 2a are arranged in the exemplary embodiment according to FIG. 1. Each primary part element 2a has a separate single or polyphase, preferably three-phase, winding 2d (shown schematically), which in particular is formed by means of tooth coils, also referred to as pole coils. As shown in FIG. 1, the maximum number of primary part elements 2a associated with the disk radius are arranged on the support plate 2b. However, fewer primary part elements 2a can also be arranged, such as half for example. A defined number of primary part elements 2a can be arranged depending on the power required. However, straight primary part elements, such as are known from conventional linear motors, can also be arranged instead of the curved primary part elements 2a. In the center of the primary part 2 can be seen the recess 2c, by means of which the primary part 2 can be arranged on a drive shaft (not shown).

FIG. 2 shows a plan view of a secondary part 3 having a plurality of secondary part elements 3a. The secondary part elements 3a when joined together form a ring or circle and can likewise be arranged on a support plate 3b. As an alternative, a ring formed by the secondary part elements 3a can be arranged on a bearing (not shown) at the recess 3c by means of struts or rods. Each secondary part element 3a has three permanent magnets 7, wherein each permanent magnet 7 can be designed in one or more parts. Each permanent magnet 7 is designed in the form of a cuboid, and the permanent magnets 7 are arranged at a defined angle with respect to one another, in particular in such a way that a circular arrangement is formed.

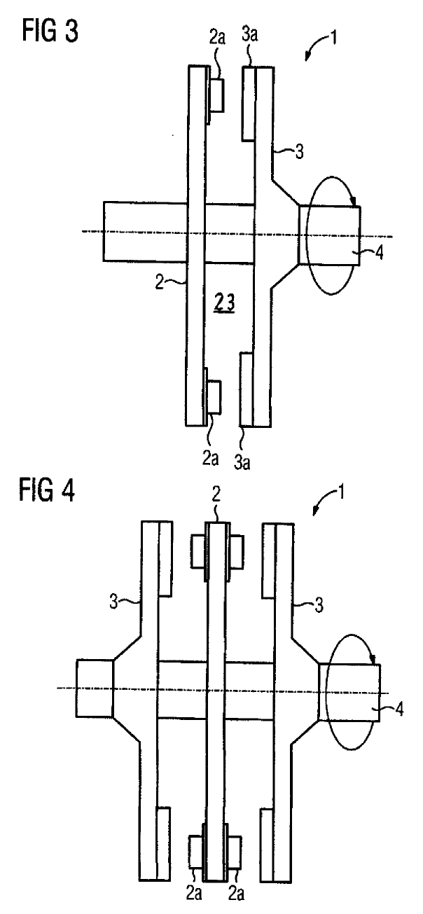

FIG. 3 shows a first embodiment of an electric disk motor 1. According to FIG. 3, the disk motor 1 represents a so-called single-comb design. The disk motor 1 has the primary part 2 and the secondary part 3 which are spaced apart from one another by a disk-shaped or ring-shaped air gap 23. The electromagnetic forces or fields act in an axial direction parallel to the drive shaft 4 between primary part 2 and secondary part 3. Secondary part elements 3a with permanent magnets are arranged on the secondary part 3. A plurality of primary part elements 2a each with a separate winding is arranged on the primary part 2. According to FIG. 3, the secondary part 3 is designed as a moving component and the primary part 2 as a stationary component. However, the primary part 2 could also be designed to be moving and the secondary part 3 to be stationary.

FIG. 4 shows a second embodiment of a disk motor 1, a so-called double-comb design. A primary part 2 is arranged between two secondary parts 3. The primary part 2 is arranged on the drive shaft 4, wherein the primary part 2 is designed as the rotor and the secondary parts 3 as stators or stationary components. A plurality of primary part elements 2a are now arranged on each side of the disk-shaped primary part 2. However, a secondary part 3 could also be arranged between two primary parts 2.

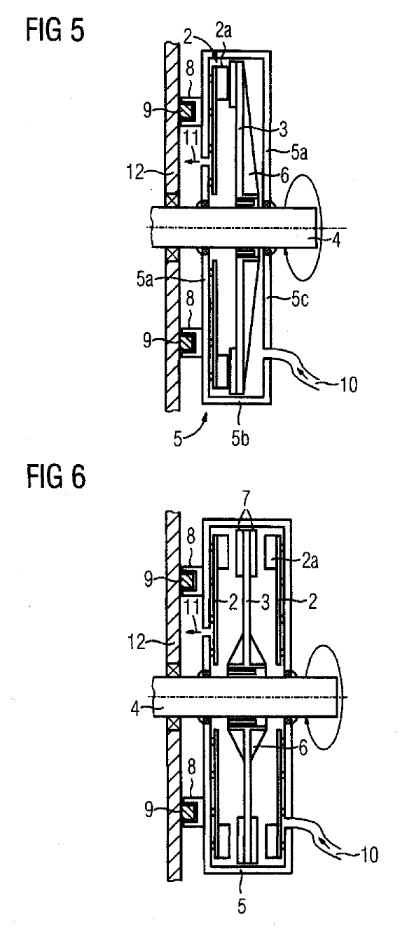

FIG. 5 is a schematic illustration of a first embodiment of an electric disk motor 1 and a machine, with the disk motor 1 being attached to the machine. The disk motor 1 is hereby designed in the form of a single-comb disk motor. The disk-shaped primary part 2 with a plurality of primary part elements 2a and the disk-shaped secondary part 3 are arranged on the drive shaft 4. The torque produced by the direct drive, i.e. by the disk motor 1, is transmitted to the machine (not shown) by means of the drive shaft 4. Primary part 2 and secondary part 3 are arranged in a motor housing 5. The primary part 2 is hereby arranged on the motor housing 5 at a distance thereto for providing ventilation behind the primary part 2. The motor housing 5 has two circular disks 5a and a hollow cylinder 5b, wherein the disks 5a are screwed to the end faces of the hollow cylinder 5b, respectively so as to cover the opposite opening of the hollow cylinder 5b. Furthermore, the motor housing 5 has an air inlet 10 and an air outlet 11 for ventilating the disk motor 1. The motor housing 5 is mounted on the drive shaft 4 by means of two bearings, in particular a fixed bearing and a floating bearing.

Furthermore, the secondary part 3 has ribs 6 to provide support and to absorb forces acting axially between primary part 2 and secondary part 3.

The primary part 2 is securely connected to the motor housing 5, wherein the motor housing 5 is bearing-mounted on the drive shaft 4 and releasably connected via a connection assembly to a supporting structure 12 which is bearing-mounted onto the drive shaft 4 of the machine. A torque support arm 8, forming part of the connection assembly, is designed in the form of a hollow cuboid which is open on one side and arranged on the machine side of the motor housing 5. A plurality of cylindrical bolts 9, forming another part of the connection assembly, is arranged on the supporting structure 12, with the torque support arm 8 resting on the bolts 9.

FIG. 6 is a schematic illustration of a second embodiment of a combination of electric disk motor 1 and a machine, with the disk motor 1 designed in the form of a double-comb disk motor. Parts corresponding with those in FIG. 5 are denoted by identical reference numerals and not explained again. The description below will center on the differences between the embodiments. In this embodiment, provision is made for two primary parts 2 which are arranged inside the motor housing 5, wherein a secondary part 3 is arranged between the two primary parts 2. A plurality of permanent magnets 7 are arranged on both sides of the secondary part 3.

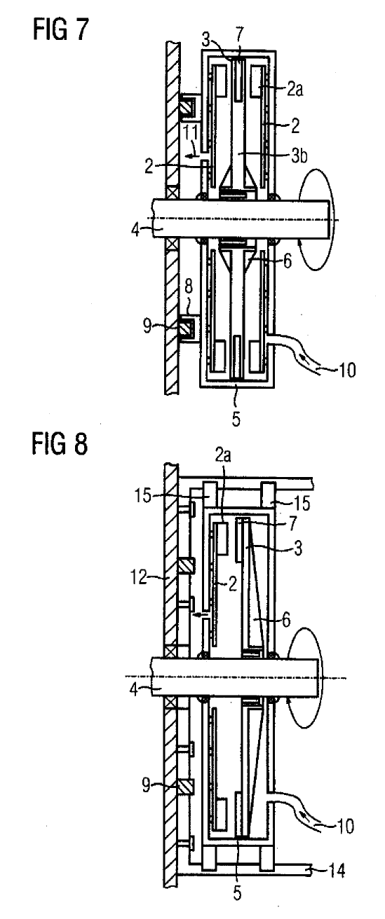

FIG. 7 is a schematic illustration of a third embodiment of a combination of electric disk motor 1 and a machine, with the disk motor 1 designed in the form of a double-comb disk motor with two primary parts 2 and a secondary part 3. Parts corresponding with those in FIG. 6 are denoted by identical reference numerals and not explained again. The description below will center on the differences between the embodiments. In this embodiment, the permanent magnets 7 of the secondary part 3 are not arranged on both sides of the disk or support plate 3b, but are integrated into the support plate 3b. Furthermore, it can be seen that the secondary part 3 is supported on both sides by means of the ribs 6 for the purpose of stabilization.

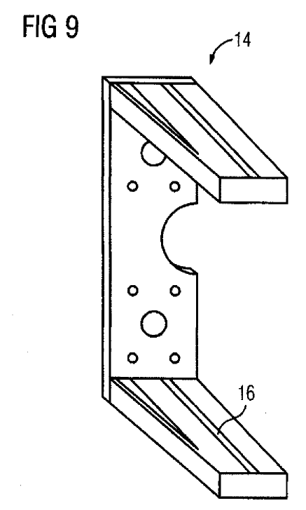

FIG. 8 is a schematic illustration of a fourth embodiment of a combination of electric disk motor 1 and a machine. Parts corresponding with those in FIG. 5 are denoted by identical reference numerals and not explained again. The description below will center on the differences between the embodiments. In this embodiment, provision is made for a support frame 14 which is fitted to the machine supporting structure 12 in order to relieve stress on the motor bearing assembly and on the drive shaft 4. The weight of the disk motor 1 including motor housing 5 does not therefore have to be borne completely by the drive shaft 4, but is partially received by the support frame 14. A plurality of fingers 15 are provided on the motor housing 5 for engagement in complementary guide rails 16 (FIG. 9) in the support frame 14. The disk motor 1 is inserted axially into the support frame 14 together with the motor housing 5 and the fingers 15. The guide rails 16 in the support frame 14 allow the disk motor 1 to move with respect to the stationary supporting structure 12 of the machine.

FIG. 9 shows a configuration of a support frame 14, which includes the guide rails 16. The support frame 14 is arranged on the supporting structure 12 and is used to receive the motor housing 5 which accommodates the disk motor 1.

By means of the supporting structure 12 of the machine, the disk motor 1 can be connected to a machine with only minor modifications to the mechanical make-up of the machine. The motor housing structure has a flexible interface to the supporting structure 12 for the purpose of torque support as well as an interface to the machine element to be driven, such as the drive shaft for example. Geometrical dimensions of the motor and prevailing spatial installation conditions can be easily matched to one another when fitting the disk motor. The safety situation of the motor system can be flexibly adjusted depending on prevailing peripheral circumstances and safety requirements resulting therefrom, such as explosion-protection requirements for example. Parasitic forces, which occur during operation of the disk motor, for example attractive forces between primary part and secondary part, are absorbed or transferred to the supporting structure 12 of the machine. In addition, the whole drive system can have a modular design. A plurality of disk motor modules, i.e. primary parts and secondary parts, can easily be mechanically coupled by means of mechanical elements on the motor housing structure for the purpose of increasing the torque. The disk motor modules can hereby be realized in both single and double-comb design.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A combination, comprising:
a machine having a drive shaft;
a supporting structure for support of the machine; and
an electric disk motor having a primary part and a secondary part, said primary part being bearing-mounted on the drive shaft and securely fixed to the supporting structure.

2. The combination of claim 1, wherein the disk motor has a motor housing bearing-mounted on the drive shaft, said primary part being securely fixed to the motor housing, and further comprising a connection assembly for releasably connecting the motor housing to the supporting structure.

3. The combination of claim 1, wherein the primary part includes a support plate, and plurality of curved or straight primary part elements arranged on the support plate and each having a single or polyphase winding.

4. The combination of claim 1, wherein the secondary part is connected in fixed rotative engagement with the drive shaft.

5. The combination of claim 1, wherein the primary part and the secondary part have each a disk-shaped configuration and are arranged opposite one another in an axial direction in side-by-side relationship on the drive shaft and form a disk-shaped or ring-shaped air gap.

6. The combination of claim 4, wherein the fixed rotative engagement between the secondary part and the drive shaft includes a member selected from the group consisting of ring clamping element, hydraulic clamping element, star washer, multiple spline, polygon connection, and key.

7. The combination of claim 1, wherein the secondary part is shrunk onto the drive shaft.

8. The combination of claim 1, wherein the secondary part has a support plate which has a plurality of radially arranged ribs.

9. The combination of claim 1, wherein the secondary part has a plurality of curved or straight secondary part elements.

10. The combination of claim 9, wherein the secondary part elements have a predefined number of cuboid-shaped permanent magnets.

11. The combination of claim 2, wherein the motor housing includes a rust-resistant material.

12. The combination of claim 2, wherein the motor housing has a hollow cylinder having opposite end faces, and two circular disks respectively screwed to the end faces of the hollow cylinder.

13. The combination of claim 12, further comprising sealing material placed between the disks and the hollow cylinder.

14. The combination of claim 12, wherein each of the disks has a central hole for press-fitting a bearing to securely fix the motor housing on the drive shaft.

15. The combination of claim 14, wherein the bearing in the central hole of one of the disks is a fixed bearing, and the bearing in the central hole of the other one of the disks is a floating bearing.

16. The combination of claim 15, wherein, wherein the floating bearing is a grooved ball bearing.

17. The combination of claim 2, wherein the connection assembly includes a torque support arm arranged on the motor housing.

18. The combination of claim 17, wherein the torque support arm is designed in the form of a hollow cuboid which is open on one side, said connection assembly including a cylindrical bolt which protrudes from the supporting structure and upon which the torque support arm rests.

19. The combination of claim 2, wherein the motor housing has an air inlet and an air outlet for ventilation of the disk motor.

20. The combination of claim 19, further comprising a ventilator arranged in a vicinity of the air inlet.

21. The combination of claim 1, further comprising a support frame arranged on the supporting structure.

22. The combination of claim 21, wherein the disk motor has a motor housing bearing-mounted on the drive shaft and having fingers for engagement in guide rails in the support frame.

23. The combination of claim 1, wherein a plurality of primary parts and/or secondary parts are arranged on the drive shaft.

24. The combination of claim 1, wherein the machine is designed as a production machine, machine tool or recycling machine.

25. A device for attaching a disk motor to a machine, comprising:
a support structure connected to a drive shaft of the machine; and
a connection assembly for releasably connecting the disk motor to the support structure, said connection assembly having a first structure mounted to the disk motor and a second structure mounted to the supporting structure and releasably engaging the first structure.

26. The device of claim 25, wherein the first structure is a torque support arm mounted to a motor housing of the disk motor, with the motor housing being bearing-mounted on the drive shaft, and the second structure is a cylindrical bolt which protrudes from the supporting structure in a direction of the motor housing for receiving the torque support arm.

27. The device of claim 26, wherein the torque support arm is designed in the form of a hollow cuboid which is open on one side for insertion of the cylindrical bolt.

28. The device of claim 26, further comprising a support frame secured to the supporting structure and situated between the supporting structure and the motor housing, said motor housing having fingers for engagement in guide rails in the support frame.
